(19) United States
(12) Patent Application Publication
(10) Pub. No.: US 2024/0178462 A1
(43) Pub. Date: May 30, 2024

(54) BATTERY

(71) Applicant: Panasonic Intellectual Property Management Co., Ltd., Osaka (JP)

(72) Inventor: EIICHI KOGA, Hokkaido (JP)

(21) Appl. No.: 18/438,436

(22) Filed: Feb. 10, 2024

Related U.S. Application Data
(63) Continuation of application No. PCT/JP2022/022901, filed on Jun. 7, 2022.

(30) Foreign Application Priority Data
Aug. 27, 2021 (JP) 2021-139375

(51) Int. Cl. H01M 10/42; H01M 4/02; H01M 4/36; H01M 4/58; H01M 10/0525; H01M 10/0562

(52) U.S. Cl. CPC H01M 10/4235; H01M 4/364; H01M 4/582; H01M 10/0562; H01M 2004/027; H01M 10/0525; H01M 2300/008

(57) ABSTRACT

A battery according to the present disclosure comprises a first electrode, a second electrode, a solid electrolyte layer disposed between the first electrode and the second electrode, and a hygroscopic material, wherein the hygroscopic material is contained in at least one selected from the group consisting of the first electrode, the second electrode, and the solid electrolyte layer, and the hygroscopic material is in contact with a side surface of the at least one selected from the group consisting of the first electrode, the second electrode, and the solid electrolyte layer.

### BACKGROUND

### 1. Technical Field

The present disclosure relates to a battery.

### 2. Description of the Related Art

Japanese Unexamined Patent Application Publication No. 2020-9596 (hereinafter, referred to as PTL 1) discloses an all-solid-state battery including a laminate casing, a power generation element housed in the laminate casing, and a moisture absorbent disposed between the laminate casing and the power generation element. In this all-solid-state battery, the power generation element and the moisture absorbent are isolated from each other by a waterproof member.

Japanese Unexamined Patent Application Publication No. 2005-56672 (hereinafter, referred to as PTL 2) discloses a secondary battery including: a battery element that includes, in sequence, a positive electrode layer on a current collector, a polymer electrolyte layer, and a negative electrode layer on a current collector; a casing hermetically enclosing the battery element; and a moisture absorbing material in the form of sheet. In this secondary battery, the moisture absorbing material sheet is disposed between the battery element and the casing in parallel to the current collector.

### SUMMARY

One non-limiting and exemplary embodiment provides a battery having higher reliability.

In one general aspect, the techniques disclosed here feature a battery comprising: a first electrode; a second electrode; a solid electrolyte layer disposed between the first electrode and the second electrode; and a hygroscopic material, wherein the hygroscopic material is contained in at least one selected from the group consisting of the first electrode, the second electrode, and the solid electrolyte layer, and the hygroscopic material is in contact with a side surface of the at least one selected from the group consisting of the first electrode, the second electrode, and the solid electrolyte layer.

The present disclosure provides a battery having higher reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates a cross-sectional view and a plan view each illustrating a schematic configuration of a battery according to a first embodiment;

FIG. 2 illustrates a cross-sectional view and a plan view each illustrating a schematic configuration of a battery according to a second embodiment;

FIG. 3 illustrates a cross-sectional view and a plan view each illustrating a schematic configuration of a battery according to a third embodiment;

FIG. 4 illustrates a cross-sectional view and a plan view each illustrating a schematic configuration of a battery according to a modification of the third embodiment; and

FIG. 5 illustrates a cross-sectional view and a plan view each illustrating a schematic configuration of a battery according to a fourth embodiment.

### DETAILED DESCRIPTIONS

Hereinafter, embodiments of the present disclosure will be described in detail with reference to the drawings.

The embodiments described below are all general or specific examples. The numbers, shapes, materials, components, positions of the components, and connections between the components in the following embodiments are examples and should not be construed as limiting of the present disclosure.

In this specification, terms indicating relationships between components such as parallel, terms indicating shapes of components such as rectangular, and numerical ranges are not strictly limited to the meanings of the terms and the ranges. The terms and the ranges may include approximation, such as variations of a few percent.

The drawings are schematic views and are not necessarily accurate. Accordingly, in the drawings, components are not necessarily to scale. In the drawings, the same reference numerals are assigned to the components having substantially the same configuration without duplicated or detailed explanation.

In the specification and the drawings, the x, y, and z axes are three axes of a three-dimensional orthogonal coordinate system. In the embodiments, the z direction corresponds to the thickness direction of the battery. In the specification, the “thickness direction” is a direction perpendicular to a plane on which layers of the battery are laminated, unless otherwise specified.

In the specification, when the battery is viewed in “plan view”, the battery is viewed in the laminating direction of layers, unless otherwise specified. In this specification, the “thickness” refers to a dimension of the battery and the layers in the laminating direction, unless otherwise specified.

In this specification, “side surfaces” of the battery and the layers of the battery refer to surfaces of the battery and the layers extending in the laminating direction, and “main surfaces” refer to surfaces other than the side surfaces, unless otherwise specified.

In this specification, when the battery is viewed in the laminating direction, “inner” in “inner side” refers to a central side of the battery, and “outer” in “outer side” refers to an outer peripheral side of the battery, for example.

In the specification, the terms “upper” and “lower” used to describe the configuration of the battery are not meant to refer to the upward direction (vertically upward) and the downward direction (vertically downward) in absolute spatial awareness. The terms are meant to refer to the relative positional relationship based on the laminating order in the laminated body. Furthermore, the terms “above” and “below” are used not only for a case where two components are spaced apart from each other with another component being interposed therebetween but also for a case where two components positioned close to each other are in contact with each other.

### First Embodiment

Hereinafter, a battery according to a first embodiment will be described.

A battery according to the first embodiment comprises a first electrode, a second electrode, a solid electrolyte layer disposed between the first electrode and the second electrode, and a hygroscopic material. The hygroscopic material is contained in at least one selected from the group consisting of the first electrode, the second electrode, and the solid electrolyte layer. In the following description, “encapsulated” may be used to refer to a situation in which a hygroscopic material is contained in a component.

In the above configuration, the hygroscopic material that absorbs moisture entering the battery prevents diffusion of moisture in the battery. This can reduce degradation of the battery characteristics caused by moisture, resulting in improvement of the reliability of the battery.

As described in “Description of the Related Art”, PTL 1 discloses an all-solid-state battery including a laminate casing, a power generation element housed in the laminate casing, and a moisture absorbent disposed between the laminate casing and the power generation element. The power generation element and the moisture absorbent are isolated from each other by a waterproof member. In the all-solid-state battery disclosed in PTL 1, the moisture absorbent is located outside the power generation element. Thus, the moisture absorbent cannot absorb moisture that has entered the power generation element. Furthermore, measures have to be taken for moisture in the power generation element, because the power generation element and the moisture absorbent are isolated from each other by a waterproof member. Furthermore, the presence of the moisture absorbent and the waterproof member makes the energy density and the capacity density smaller and also makes the manufacturing process complex. As can be seen from the above, the all-solid-state battery disclosed in PTL 1 has a battery reliability problem.

PTL 2 discloses a secondary battery that includes the sheet-shaped moisture absorbing material disposed between the current collector and the casing, which hermetically encloses the battery element. The moisture absorbing material is located between the current collector and the casing, i.e., the moisture absorbing material is located outside the battery element in the secondary battery disclosed in PTL 2. Thus, measures also have to be taken for moisture in the battery element of the secondary battery disclosed in PTL 2, like that of the all-solid-state battery disclosed in PTL 1.

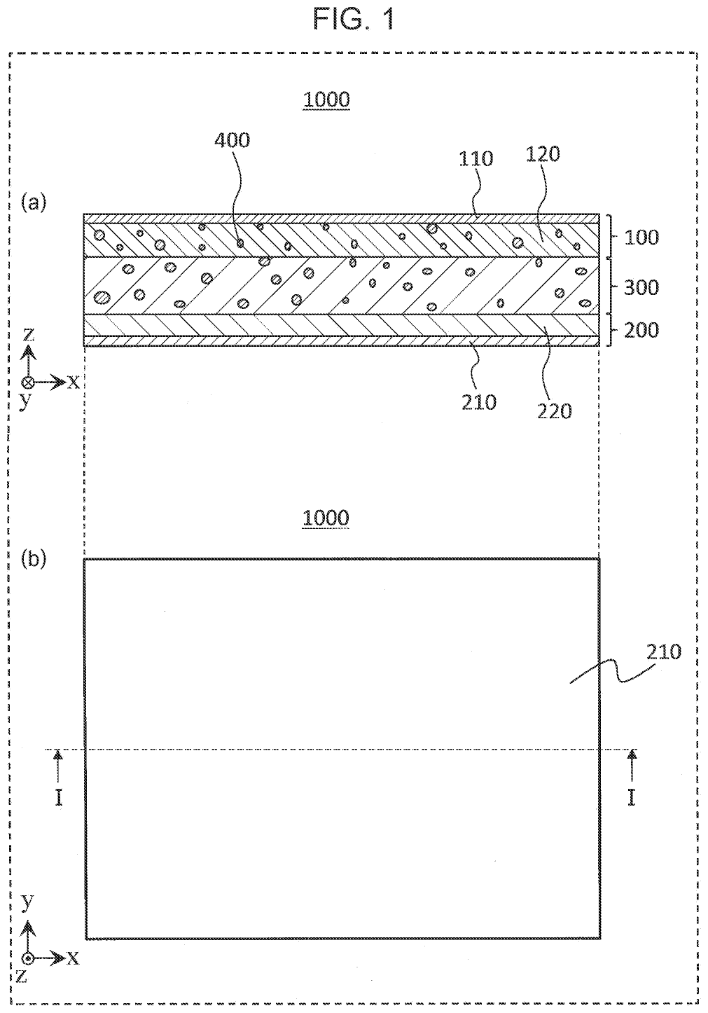

FIG. 1 illustrates a cross-sectional view and a plan view each illustrating a schematic configuration of a battery 1000 according to a first embodiment.

FIG. 1(a) is a cross-sectional view of the battery 1000 according to the first embodiment. FIG. 1(b) is a plan view of the battery 1000 according to the first embodiment viewed from below in the z direction. FIG. 1(a) illustrates a cross section taken along line I-I in FIG. 1(b).

As illustrated in FIG. 1(a), the battery 1000 includes a first electrode 100, a second electrode 200, a solid electrolyte layer 300 disposed between the first electrode 100 and the second electrode 200, and a hygroscopic material 400. The hygroscopic material 400 is encapsulated in at least one selected from the group consisting of the first electrode 100, the second electrode 200, and the solid electrolyte layer 300.

In FIG. 1(a), the hygroscopic material 400 is encapsulated in the first electrode 100 and the solid electrolyte layer 300.

The battery 1000 is, for example, an all-solid-state battery.

The first electrode 100 includes, for example, a first current collector 110 and a first active material layer 120.

The second electrode 200 includes, for example, a second current collector 210 and a second active material layer 220.

The first current collector 110, the first active material layer 120, the solid electrolyte layer 300, the second active material layer 220, and the second current collector 210 each may have a rectangular outline shape in plan view. The outline shape is not limited to rectangular.

In FIG. 1, the first current collector 110, the first active material layer 120, the solid electrolyte layer 300, the second active material layer 220, and the second current collector 210 have the same size and the same outline in plan view, but this should not be construed as limiting.

In plan view, the first active material layer 120 may be smaller than the second active material layer 220.

In plan view, the first active material layer 120 and the second active material layer 220 may be smaller than the solid electrolyte layer 300.

For example, if the solid electrolyte layer 300 covers at least one of the first active material layer 120 or the second active material layer 220, the solid electrolyte layer 300 may be partly in contact with at least one of the first current collector 110 or the second current collector 210.

The first electrode 100 may be a positive electrode, and the second electrode 200 may be a negative electrode. In this case, the first current collector 110 is a positive electrode current collector, the first active material layer 120 is a positive electrode active material layer, the second current collector 210 is a negative electrode current collector, and the second active material layer 220 is a negative electrode active material layer.

The first electrode 100 may be a negative electrode, and the second electrode 200 may be a positive electrode.

Hereinafter, the first current collector 110 and the second current collector 210 are referred to collectively and simply as “current collectors” in some cases. The first active material layer 120 and the second active material layer 220 are referred to collectively and simply as “active material layers” in some cases.

The current collectors only need to be formed of a conductive material. Examples of the conductive material include stainless steel, nickel (Ni), aluminum (Al), iron (Fe), titanium (Ti), copper (Cu), palladium (Pd), gold (Au), platinum (Pt), and an alloy of two or more of these.

The current collector may have a foil-like shape, a plate-like shape, or a mesh-like shape.

The material of the current collector may be selected in view of the manufacturing process, the operating temperature, the operating pressure, the battery operating potential applied to the collector, or the conductivity. The material of the current collector may be selected in view of the tensile strength or heat resistance required to the battery. The current collector may be a high-strength electrolytic copper foil or a clad material including laminated dissimilar metal foils.

The current collector may have a thickness of greater than or equal to 10 μm and less than or equal to 100 μm.

The surface of the current collector may be machined into a roughened uneven surface to enhance adhesion to the active material layer (the first active material layer 120 or the second active material layer 220). This improves, for example, the interfacial bonding strength of the current collector and improves the mechanical and thermal reliability and the cycling characteristics of the battery 1000. Furthermore, the above configuration increases the contact area between the current collector and the active material layer, and thus the electrical resistance is reduced.

The first active material layer 120 may be in contact with the first current collector 110. The first active material layer 120 may cover the entire main surface of the first current collector 110.

The positive electrode active material layer contains a positive electrode active material.

A positive electrode active material is a substance in which metal ions such as lithium (Li) ions and magnesium (Mg) ions are inserted into or removed from the crystal structure at a higher potential than the negative electrode and is oxidized or reduced accordingly.

The positive electrode active material may be a compound containing lithium and a transition metal element. Examples of the compound include an oxide that contains lithium and a transition metal element and a phosphate compound that contains lithium and a transition metal element.

Examples of the oxide that contains lithium and a transition metal element include lithium nickel composite oxides such as LiNiₓM₁₋ₓO₂ (where M is at least one selected from the group consisting of Co, Al, Mn, V, Cr, Mg, Ca, Ti, Zr, Nb, Mo, and W, and x satisfies 0<x≤1), layered oxides such as lithium cobalt oxide (LiCoO₂), lithium nickel oxide (LiNiO₂), and lithium manganese oxide (LiMn₂O₄), and lithium manganese oxides having a spinel structure (such as LiMn₂O₄, Li₂MnO₃, and LiMO₂).

An example of the phosphate compound containing lithium and a transition metal element is lithium iron phosphate having an olivine structure (LiFePO₄).

As the positive electrode active material, sulfur (S) and sulfides such as lithium sulfide (Li₂S) may be used. In this case, lithium niobate (LiNbO₃) or the like may coat or may be added to the positive electrode active material particles.

As the positive electrode active material, one of the above materials may be used, or two or more of the above materials may be used in combination.

To improve lithium-ion conductivity or electronic conductivity, the positive electrode active material layer may contain, in addition to the positive electrode active material, a material other than the positive electrode active material. In other words, the positive electrode active material layer may be a composite layer. Examples of such a material include solid electrolytes such as inorganic solid electrolytes and sulfide solid electrolytes, conductive aids such as acetylene black, and binders such as polyethylene oxide and polyvinylidene fluoride.

The positive electrode active material layer may have a thickness of, for example, greater than or equal to 5 μm and less than or equal to 300 μm.

The hygroscopic material 400 may be a particulate material. This allows the hygroscopic material 400 to be dispersed in the battery 1000, thus protecting the components of the battery 1000 from moisture that is present in the battery 1000. The first electrode 100, the second electrode 200, and the solid electrolyte layer 300, which are the components of the battery 1000, correspond to the components of the power generation clement of the all-solid-state battery disclosed in PTL 1. The hygroscopic material 400 may be contained in the slurry or paste for forming the battery 1000. In such a case, the hygroscopic material 400 can be readily encapsulated in the components of the battery 1000 in the manufacturing process of the battery 1000. The hygroscopic material 400 may be spherical or ellipsoidal.

When the hygroscopic material 400 is a particulate material, the particle size may be greater than or equal to 0.5 μm and less than or equal to 20 μm. This enables the hygroscopic material 400 to absorb moisture more effectively, because the overall surface area of the hygroscopic material 400 increases as the particle size of the hygroscopic material 400 decreases. The hygroscopic material 400 may be finely powdered before dispersed. This enables the hygroscopic material 400 to absorb more moisture.

The solid electrolyte layer 300 may contain the hygroscopic material 400 in an amount of greater than or equal to 0.1 vol % and less than or equal to 5.0 vol %. The volume percentage of the hygroscopic material 400 in the solid electrolyte layer 300 can be determined by cross-sectional observation using a scanning electron microscope (SEM) image. The area ratio of the hygroscopic material 400 to the solid electrolyte layer 300 is calculated, and the value of the ratio is used as the volume percentage. The cross-section of the solid electrolyte layer 300 used for the cross-sectional observation may be an ion-polished surface.

The first electrode 100 may contain the hygroscopic material 400 in an amount of greater than or equal to 0.03 vol % and less than or equal to 0.2 vol %. The volume percentage of the hygroscopic material 400 in the first electrode 100 is determined by the same method as the volume percentage of the hygroscopic material 400 in the solid electrolyte layer 300.

The second electrode 200 may also contain the hygroscopic material 400. When the second electrode 200 contains the hygroscopic material 400, the second electrode 200 may contain the hygroscopic material 400 in an amount of greater than or equal to 0.03 vol % and less than or equal to 0.2 vol %. The volume percentage of the hygroscopic material 400 in the second electrode 200 is determined by the same method used to determine that in the first electrode 100.

The hygroscopic material 400 may be in contact with a side surface of at least one selected from the group consisting of the first electrode 100, the second electrode 200, and the solid electrolyte layer 300. In other words, the hygroscopic material 400 may be encapsulated in at least one selected from the group consisting of the first electrode 100, the second electrode 200, and the solid electrolyte layer 300 and may be in contact with the inner side surface(s) of the selected component(s). This enables moisture absorption at the side surface of the battery 1000, preventing intrusion of moisture into the components of the battery 1000.

The hygroscopic material 400 that is encapsulated in at least one selected from the group consisting of the first electrode 100, the second electrode 200, and the solid electrolyte layer 300, which are the components of the battery 1000, may attach to the outer side surfaces of the components. This can further reduce degradation of the battery characteristics caused by moisture.

The hygroscopic material 400 may be present between the particles or in the voids of the solid electrolyte and the active material.

The hygroscopic material 400 may cover at least a portion of the surface of the solid electrolyte particle. In other words, at least one selected from the group consisting of the first electrode 100, the second electrode 200, and the solid electrolyte layer 300 may contain the solid electrolyte particle, and the hygroscopic material 400 may cover at least a portion of the surface of the solid electrolyte particle. This protects the solid electrolyte particle, whose properties are easily degraded by moisture, from moisture.

Alternatively, the hygroscopic material 400 may cover at least a portion of the surface of the active material particle. In other words, the first electrode 100 may contain an active material particle, and the hygroscopic material 400 may cover at least a portion of the surface of the active material particle. This protects the active material particle from moisture.

The hygroscopic material 400 may cover at least a portion of the surface of an aggregate of particles. Examples of the aggregate of particles here include an aggregate of solid electrolyte particles, an aggregate of active material particles, and an aggregate of solid electrolyte particles and active material particles. This protects the solid electrolyte particles and the active material particles, whose properties are easily degraded by moisture, from moisture.

The particulate hygroscopic material 400 that is placed in components whose properties are easily degraded by moisture selectively absorbs moisture that has entered the components, and thus can reduce moisture diffusion to other components (e.g., moisture-sensitive materials). This reduces degradation of properties of the battery 1000 caused by moisture intrusion.

The hygroscopic material 400 may be uniformly dispersed in at least one selected from the group consisting of the first electrode 100, the second electrode 200, and the solid electrolyte layer 300.

The hygroscopic material 400 may be encapsulated in all the first electrode 100, the second electrode 200, and the solid electrolyte layer 300.

The solid electrolyte layer 300 may contain the hygroscopic material 400 in a higher volume percentage than the first electrode 100 and the second electrode 200. This protects the solid electrolyte layer 300, whose properties are easily degraded by moisture, from moisture.

The hygroscopic material 400 may be any material having moisture absorption properties. The hygroscopic material 400 may be a material that can react with moisture or adsorb moisture, and the material can react with more moisture or adsorb more moisture than the solid electrolyte of the battery 1000. For example, the hygroscopic material 400 may be a material whose rate of mass change (i.e., amount of moisture absorption) determined by an exposure aging test (e.g., exposure time of 0.5 to 1 hour) performed at room temperature (e.g., 25° C.) and constant water vapor pressure (i.e., constant humidity) is greater than that of the solid electrolyte of the battery 1000.

The hygroscopic material 400 may be a non-conductive material. The term “non-conductive material” here means, for example, a material whose electronic conductivity is less than or equal to 1% of that of the solid electrolyte used in the battery 1000.

The hygroscopic material 400 may be a non-ion-conductive material. The term “non-ion-conductive material” here means, for example, a material whose ion conductivity is less than or equal to 1% of that of the solid electrolyte of the battery 1000.

The hygroscopic material 400 may be an inorganic material.

The hygroscopic material 400 may be a material that is not oxidized or reduced by charging or discharging of the battery 1000.

The hygroscopic material 400 may contain an ammonium halide. This enables the hygroscopic material 400 to maintain the moisture absorption performance even when the battery 1000 is heated to a high temperature during operation or manufacturing of the battery 1000. The sublimation point of ammonium chloride and that of ammonium bromide are about 330° C. and about 400° C., respectively. Furthermore, ammonium halides are highly moisture absorbent. The hygroscopic material 400 in the form of powder (e.g., ammonium halide powder) may be dispersed in the paste that forms the first electrode 100, the second electrode 200, or the solid electrolyte layer 300. This enables the battery 1000 containing the hygroscopic material 400 to be readily produced by coating the paste. The halide solid electrolyte and an ammonium halide may be used in combination. At least one selected from the group consisting of the first electrode 100, the second electrode 200, and the solid electrolyte layer 300 may contain the halide solid electrolyte and the ammonium halide. Halides in general are likely to have a larger coefficient of thermal expansion than other compounds such as oxides. If difference in coefficient of thermal expansion between adjacent materials is large, structural defects such as delamination and cracks at the interface may be caused due to temperature cycling. The structural defects can be reduced when the solid electrolyte and the hygroscopic material 400 are both composed of halides. Thus, the battery 1000 can have higher reliability.

The ammonium halide may be ammonium chloride or ammonium bromide. In other words, the hygroscopic material 400 may contain at least one selected from the group consisting of ammonium chloride and ammonium bromide. This enables the battery 1000 to have high stability at high temperatures. For example, ammonium chloride (NH₄Cl) undergoes hydrolysis (i.e., takes up water) when brought in contact with moisture and forms NH₄(OH) and HCl. This reaction allows the ammonium chloride to function as a hygroscopic material. The same holds for the ammonium bromide.

When a halide solid electrolyte and an ammonium halide are used in combination, both the halide solid electrolyte and the ammonium halide may contain at least one selected from the group consisting of chlorine and bromine. This enables the battery 1000 to have high ion conductivity and moisture absorption properties.

The hygroscopic material 400 may include two or more types of ammonium halides. For example, both ammonium chloride and ammonium bromide may be used. The temperature durability of the battery 1000 can be controlled by changing the mixing ratio of two or more types of ammonium halides. For example, the high-temperature durability can be increased to about 400° C. by increasing the proportion of ammonium bromide. Thus, defects such as cracks are less likely to be caused in the battery 1000 by thermal shock or temperature cycling. In other words, the battery 1000 can maintain the moisture absorption performance of the hygroscopic material 400 and have high reliability even when having a high-temperature thermal history.

The presence of ammonium halide in the battery may be evaluated by X-ray fluorescence (XRF) analysis.

The state or composition of the hygroscopic material 400 may be analyzed by performing compositional analysis (e.g., point or plane analysis) using an electron probe microanalyzer (EPMA) or energy dispersive X-ray spectroscopy (EDS) on a polished cross section of the battery 1000 processed by an ion polisher or the like.

The second active material layer 220 may be in contact with the second current collector 210. The second active material layer 220 may cover the entire main surface of the second current collector 210.

The negative electrode active material layer contains the negative electrode active material.

A negative electrode active material is a substance in which metal ions such as lithium (Li) ions and magnesium (Mg) ions are inserted into or removed from the crystal structure at a lower potential than the positive electrode and is oxidized or reduced accordingly.

Examples of the negative electrode active material include carbon materials such as natural graphite, artificial graphite, graphite carbon fiber, and resin heat-treated carbon, and alloy base materials that form a composite material with the solid electrolyte. Examples of the alloy base materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆, oxides of lithium and a transition metal element such as lithium titanate (Li₄Ti₅O₁₂), and metal oxides such as zinc oxide (ZnO) and silicon oxide (SiOₓ).

As the negative electrode active material, one of the above materials may be solely used, or two or more of the above materials may be used in combination.

To improve the lithium-ion conductivity or the electron conductivity, the negative electrode active material layer may contain, in addition to the negative electrode active material, a material other than the negative electrode active material. Examples of such a material include solid electrolytes such as inorganic solid electrolytes and sulfide solid electrolytes, conductive aids such as acetylene black, and binders such as polyethylene oxide and polyvinylidene fluoride.

The negative electrode active material layer may have a thickness of, for example, greater than or equal to 5 μm and less than or equal to 300 μm.

The solid electrolyte layer 300 contains a solid electrolyte. The solid electrolyte layer 300 contains, for example, a solid electrolyte as a main component. Herein, the main component means a component most abundant by mass in the solid electrolyte layer 300. The solid electrolyte layer 300 may only include a solid electrolyte material.

The solid electrolyte may be any known solid electrolyte for batteries that has ion conductivity. The solid electrolyte may be a solid electrolyte that conducts metal ions such as lithium ions and magnesium ions.

Examples of the solid electrolyte include sulfide solid electrolytes, oxide solid electrolytes, and halide solid electrolytes.

Examples of the sulfide solid electrolytes include Li₂S—P₂S₅ system, Li₂S—SiS₂ system, Li₂S—B₂S₃ system, Li₂S—GeS₂ system, Li₂S—SiS₂—LiI system, Li₂S—SiS₂—Li₃PO₄ system, Li₂S—Ge₂S₂ system, Li₂S—GeS₂—P₂S₅ system, and Li₂S—GeS₂—ZnS system.

Examples of the oxide solid electrolytes include lithium-containing metal oxides, lithium-containing metal nitrides, lithium phosphate (Li₃PO₄), and lithium-containing transition metal oxides. Examples of the lithium-containing metal oxides include Li₂O—SiO₂ and Li₂O—SiO₂—P₂O₅. An example of lithium-containing metal nitrides or lithium-containing metal oxynitrides is LiₓP_{y}O_{1-z}N_{z} (0<z≤1). An example of the lithium-containing transition metal oxide is lithium titanium oxide.

An example of the halide solid electrolytes is a compound containing Li, M, and X. Here, M is at least one selected from the group consisting of metallic elements other than Li and metalloid elements. X is at least one selected from the group consisting of F, Cl, Br, and I.

The “metalloid elements” include B, Si, Ge, As, Sb, and Te. The “metal elements” are all elements in Groups 1 to 12 of the periodic table (except hydrogen) and all elements in Groups 13 to 16 of the periodic table (except B, Si, Ge, As, Sb, Te, C, N, P, O, S, and Se).

To improve the ion conductivity of the halide solid electrolyte, M may contain Y. M may be Y.

The halide solid electrolyte may be, for example, a compound represented by LiₐMe_{b}Y_{c}X₆. Here, a+mb+3c=6 and c>0 are satisfied. The value of m represents the valence of Me.

To improve the ion conductivity of halide solid electrolytes, Me may be at least one selected from the group consisting of Mg, Ca, Sr, Ba, Zn, Sc, Al, Ga, Bi, Zr, Hf, Ti, Sn, Ta, and Nb.

To improve the ion conductivity of the halide solid electrolyte, X may contain at least one selected from the group consisting of Cl and Br.

The halide solid electrolyte may contain at least one selected from the group consisting of Li₃YCl₆ and Li₃ YBr₆.

As a solid electrolyte, one of the above materials may be solely used, or two or more of the above materials may be used in combination.

The solid electrolyte layer 300 may contain a binder such as polyethylene oxide and polyvinylidene fluoride in addition to the solid electrolyte.

The solid electrolyte layer 300 may have a thickness of, for example, greater than or equal to 5 μm and less than or equal to 150 μm.

The material of the solid electrolyte may comprise an aggregate of particles. Alternatively, the material of the solid electrolyte may have a sintered structure.

### Second Embodiment

Hereinafter, a battery according to a second embodiment will be described. Description of the features described in the above first embodiment will be omitted as appropriate.

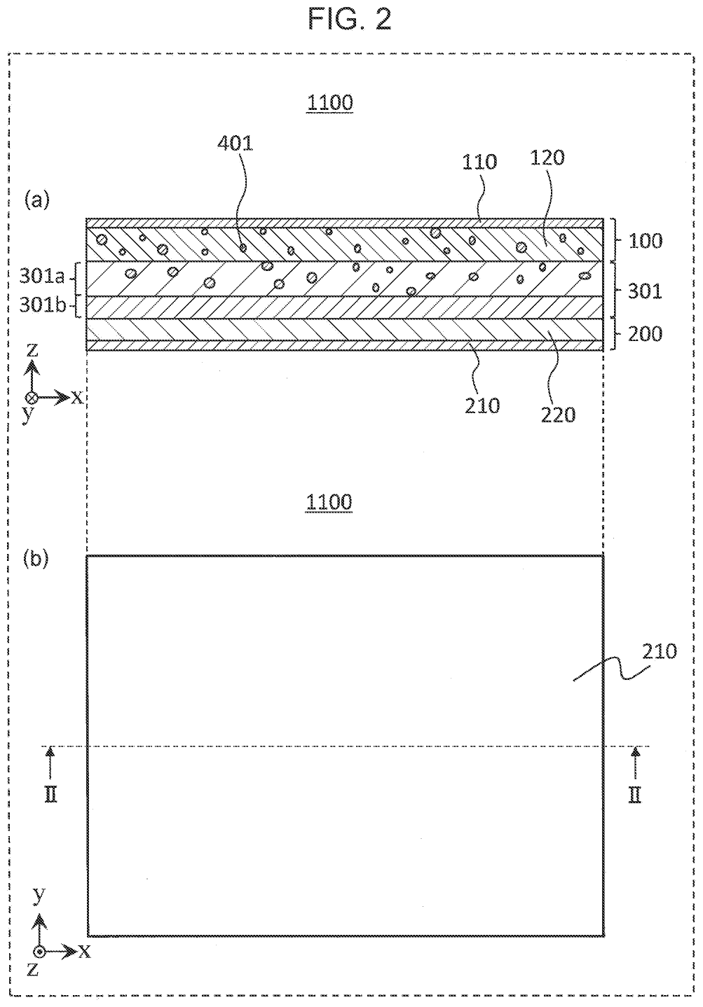

FIG. 2 illustrates a cross-sectional view and a plan view each illustrating a schematic configuration of a battery 1100 according to a second embodiment.

FIG. 2(a) is a cross-sectional view of the battery 1100 according to the second embodiment. FIG. 2(b) is a plan view of the battery 1100 according to the second embodiment viewed from below in the z direction. The cross section in FIG. 2(a) is taken along line II-II in FIG. 2(b).

As illustrated in FIG. 2(a), in the battery 1100, the solid electrolyte layer 301 includes a first solid electrolyte layer 301a and a second solid electrolyte layer 301b. The first solid electrolyte layer 301a is located between the first electrode 100 and the second solid electrolyte layer 301b. The hygroscopic material 401 is encapsulated in the solid electrolyte layer 301. The first solid electrolyte layer 301a contains the hygroscopic material 401 in a higher volume percentage than the second solid electrolyte layer 301b.

As illustrated in FIG. 2(a), in the battery 1100, the hygroscopic material 401 is also encapsulated in the first electrode 100.

The above configuration can reduce intrusion of moisture into the first electrode 100. Thus, the battery can have high reliability even when the first electrode 100 has low water resistance.

As illustrated in FIG. 2(a), the second solid electrolyte layer 301b may contain no hygroscopic material 401.

Although the hygroscopic material 401 illustrated in FIG. 2(a) is a particulate material, the hygroscopic material contained in the first solid electrolyte layer 301a may be in the form of layer. For example, a hygroscopic material may form a layer along the interface between the first solid electrolyte layer 301a and the first electrode 100.

The first solid electrolyte layer 301a may contain a larger amount of the hygroscopic material 401 in an area adjacent to the first electrode 100. In other words, the concentration of the hygroscopic material 401 increases toward the first electrode 100 in the first solid electrolyte layer 301a. This can reduce intrusion of moisture into the first electrode 100.

The solid electrolyte forming the first solid electrolyte layer 301a may have a different composition than the solid electrolyte forming the second solid electrolyte layer 301b. With this configuration, solid electrolytes can be suitably selected for the positive electrode and the negative electrode. For example, if the first electrode 100 is a positive electrode, the first solid electrolyte layer 301a may contain a halide solid electrolyte and the second solid electrolyte layer 301b may contain sulfide from a viewpoint of electrochemical stability. The solid electrolyte forming the first solid electrolyte layer 301a may have low water resistance, because the first solid electrolyte layer 301a contains the hygroscopic material 401.

### Third Embodiment

Hereinafter, a battery according to a third embodiment will be described. Description of the features described in the above embodiments will be omitted as appropriate.

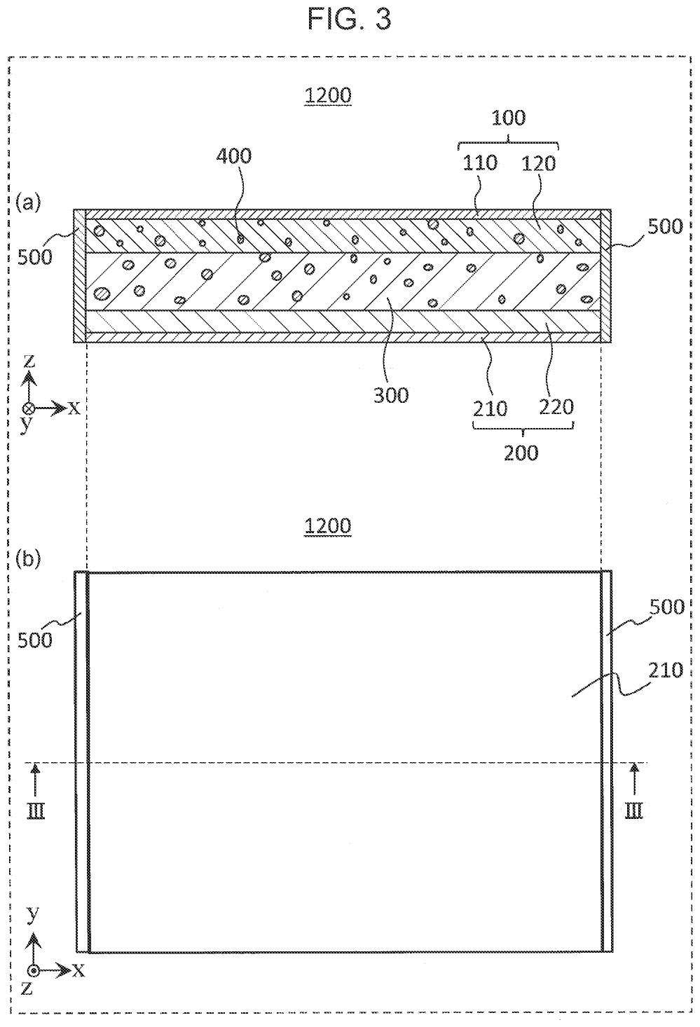

FIG. 3 illustrates a cross-sectional view and a plan view each illustrating a schematic configuration of a battery 1200 according to a third embodiment.

FIG. 3(a) is a cross-sectional view of the battery 1200 according to the third embodiment. FIG. 3(b) is a plan view of the battery 1200 according to the third embodiment viewed from below in the z direction. FIG. 3(a) illustrates a cross section taken along line III-III in FIG. 3(b).

In contrast to the battery 1000 according to the first embodiment, the battery 1200 further includes a hygroscopic layer 500 covering at least a portion of a side surface of at least one selected from the group consisting of the first electrode 100, the second electrode 200, and the solid electrolyte layer 300. As illustrated in FIG. 3(a), the battery 1200 may include the hygroscopic layers 500 covering the side surfaces of the battery 1200.

The above configuration can reduce intrusion of moisture into the components of the battery 1200 through the side surfaces of the battery 1200. Thus, the battery 1200 can have high water resistance. Furthermore, the hygroscopic layer 500 can also function as a coating layer that can prevent adhesion of foreign substances and shedding of the active material layer. In this way, the hygroscopic layer 500 can improve the reliability of the battery 1200.

The hygroscopic layer 500 contains the hygroscopic material. The hygroscopic material may be the same as or different from the hygroscopic material 400 encapsulated in at least one selected from the group consisting of the first electrode 100, the second electrode 200, and the solid electrolyte layer 300.

The hygroscopic layer 500 may contain ammonium halide.

A paste including particles containing an ammonium halide and an organic binder may be applied to a side surface of at least one selected from the group consisting of the first electrode 100, the second electrode 200, and the solid electrolyte layer 300 and dried to form the hygroscopic layer 500.

The hygroscopic layer 500 may have a thickness of greater than or equal to 1 μm and less than or equal to 30 μm.

The hygroscopic layer 500 may be disposed so as not to cover the side surfaces of the second electrode 200.

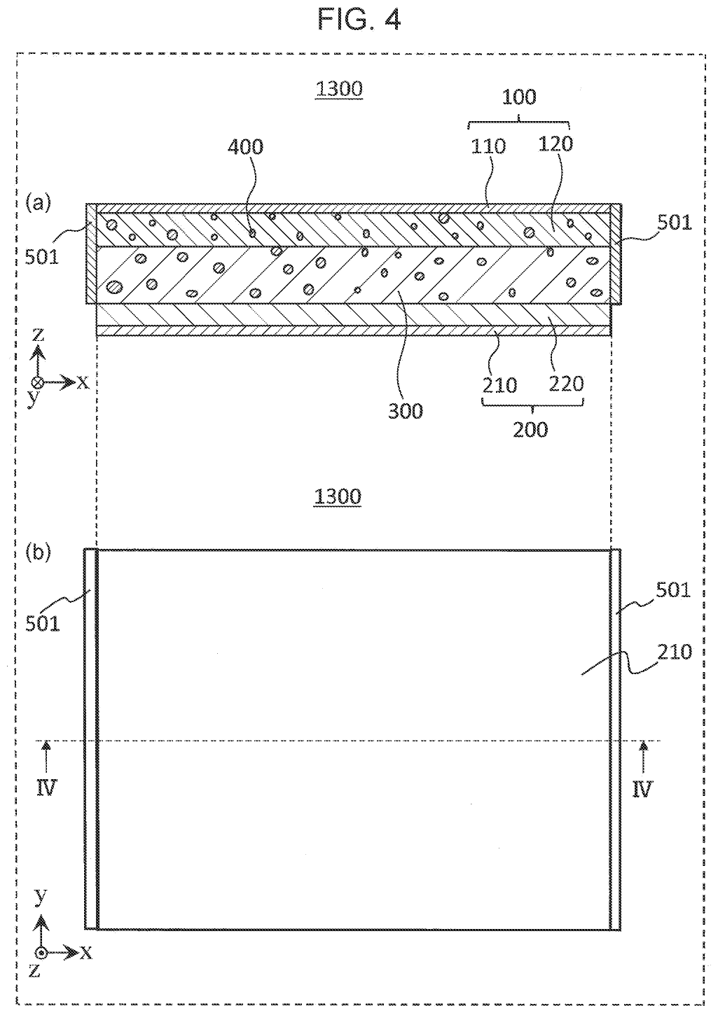

FIG. 4 illustrates a cross-sectional view and a plan view each illustrating a schematic configuration of a battery 1300 according to a modification of the third embodiment.

FIG. 4(a) is a cross-sectional view of the battery 1300. FIG. 4(b) is a plan view of the battery 1300 viewed from below in the z direction. FIG. 4(a) illustrates a cross section taken along line IV-IV in FIG. 4(b).

As illustrated in FIG. 4(a), the battery 1300 includes a hygroscopic layer 501 covering the side surfaces of the first electrode 100 and the solid electrolyte layer 300 of the battery 1300. The hygroscopic layer 501 does not cover the side surfaces of the second electrode 200.

The second electrode 200 may be a negative electrode.

The above configuration does not require the hygroscopic layer to cover the side surfaces of a layer (e.g., a negative electrode formed of carbon or a silicon-based material) that undergoes great expansion and contraction during charging and discharging. This can prevent delamination of the hygroscopic layer caused by repeated expansion and contraction. Thus, the battery 1300 can have higher reliability.

### Fourth Embodiment

Hereinafter, a battery according to a fourth embodiment will be described. Description of the features described in the above embodiments will be omitted as appropriate.

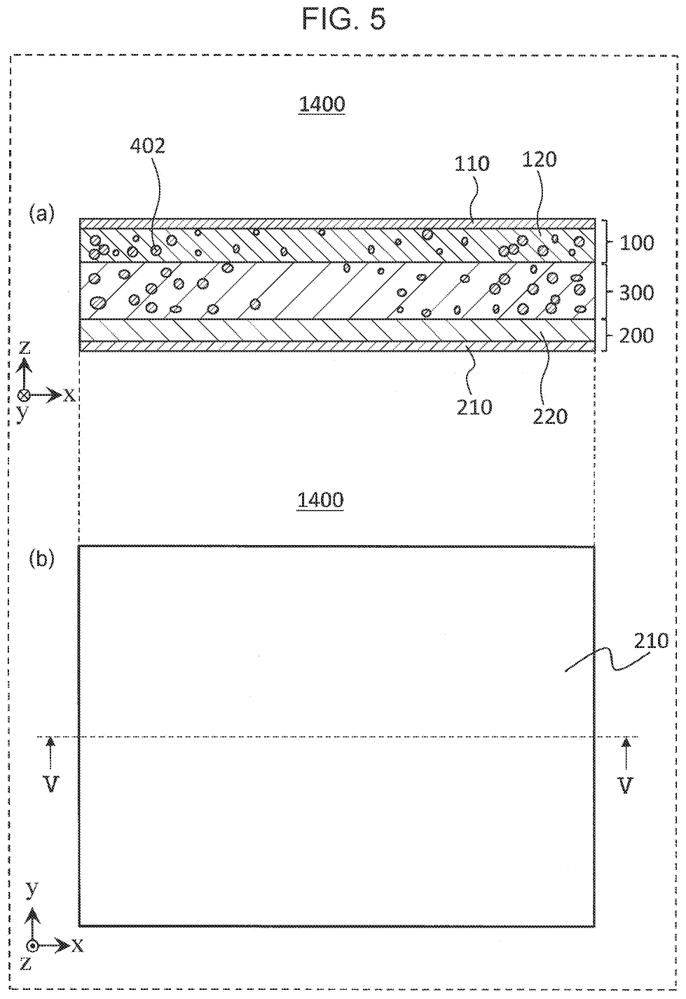

FIG. 5 illustrates a cross-sectional view and a plan view each illustrating a schematic configuration of a battery 1400 according to a fourth embodiment.

FIG. 5(a) is a cross-sectional view of the battery 1400 according to the fourth embodiment. FIG. 5(b) is a plan view of the battery 1400 according to the fourth embodiment viewed from below in the z direction. FIG. 5(a) illustrates a cross section taken along line V-V in FIG. 5(b).

As illustrated in FIG. 5(a), when the battery 1400 is viewed in plan view, the hygroscopic material 402 is present in a higher volume percentage in an outer peripheral area of the battery 1400 than in a central area.

This configuration can improve the moisture absorption performance in the outer peripheral area the battery 1400, which is easily accessible to moisture. Thus, the battery 1400 can have higher reliability.

The area containing the hygroscopic material 402 in a higher volume percentage may have rectangular, circular, or polygonal inner peripheral shape in plan view. The shapes enable the interior of the battery to be protected by the area containing the hygroscopic material 402 in a high concentration, and thus the battery can have higher reliability.

The concentration of the hygroscopic material 402 may continuously increase from the center of the battery 1400 toward the outer edge, or it may increase in stages.

### Method of Producing Battery

The following describes an example of a method of producing a battery according to the present disclosure.

Here, a method of producing the battery 1000 according to the first embodiment will be described as an example.

In the following description, the first electrode 100 is a positive electrode and the second electrode 200 is a negative electrode.

First, pastes for print-forming the positive electrode active material layer, and the negative electrode active material layer are produced.

As a solid electrolyte used in a composite material of the active material layer, a powder having an average particle size of about 3 μm and including a halide solid electrolyte as a main component is provided, for example. The halide solid electrolyte has an ion conductivity of, for example, 1×10⁻³ S/cm to 3×10⁻³ S/cm. Examples of the halide solid electrolyte include Li₃YCl₆ and Li₃YBr₆.

As the positive electrode active material, a powder of Li—Ni—Co—Al composite oxide (e.g., LiNi_{0.8}Co_{0.15}Al_{0.05}O₂) having an average particle size of about 5 μm and having a layered structure is used, for example.

As the hygroscopic material, an ammonium chloride powder having an average particle size of about 1 μm is used, for example.

The above-described powders of the positive electrode active material, the solid electrolyte, and the hygroscopic material are dispersed in an organic solvent or the like to produce the paste for the positive electrode active material layer. The paste for the positive electrode active material layer is produced, for example, in a three-roll mill.

As the negative electrode active material, a natural graphite powder having an average particle size of about 10 μm is used, for example.

The above-described powders of the negative electrode active material and the solid electrolyte are dispersed in an organic solvent or the like to produce the paste for the negative electrode active material layer.

Next, as the positive current collector and the negative current collector, copper foils having a thickness of about 30 μm are provided. By a screen-printing method, the pastes for the positive electrode active material layer and the negative electrode active material layer each containing the hygroscopic material are printed on the copper foils. The pastes are printed in a predetermined shape and at a thickness ranging from about 50 μm to about 100 μm. The pastes for the positive electrode active material layer and the negative electrode active material layer are dried at 80° C. to 130° ° C. In this way, the positive electrode active material layer is formed on the positive electrode current collector, and the negative electrode active material layer is formed on the negative electrode current collector. The positive electrode and the negative electrode each have a thickness of 30 μm to 60 μm.

Next, the above-described powders of the solid electrolyte and the hygroscopic material are dispersed in an organic solvent or the like to produce a paste for the solid electrolyte layer. On the positive electrode and the negative electrode, the paste for the solid electrolyte layer is printed at a thickness of, for example, about 100 μm using a metal mask. The positive electrode and the negative electrode having the printed paste for the solid electrolyte layer are dried at 80° C. to 130° C.

Next, the positive electrode and the negative electrode each having the printed solid electrolyte are laminated such that the solid electrolytes are in contact with each other. The laminated body is housed in a die having a rectangular outline.

Next, an elastic sheet having a thickness of 70 μm and an elastic modulus of about 5×10⁶ Pa is inserted between a pressure die punch and the laminated body. This configuration allows application of pressure to the laminated body through the elastic sheet. Then, the pressure die is then pressurized at a pressure of 300 MPa for 90 seconds while heated to 50° C. In this way, a laminated body including the positive electrode current collector, the positive electrode active material layer, the solid electrolyte layer, the negative electrode active material layer, and the negative electrode current collector is produced. The positive electrode active material layer and the solid electrolyte layer each encapsulate a hygroscopic material.

The method of producing the battery and the order of steps should not be limited to the above-described example.

In the above-described method, the paste for the positive electrode active material layer, the paste for the negative electrode active material layer, and the paste for the solid electrolyte layer are applied by printing, but the method should not be limited to this example. Examples of the printing method include a doctor blade method, a calender method, a spin coating method, a dip coating method, an inkjet method, an offset method, a die coating method, and a spray method.

The batteries according to the present disclosure were described above with reference to the embodiments, but the present disclosure should not be limited to the embodiments. Without departing from the gist of the present disclosure, various changes conceived by a person skilled in the art may be added to the embodiments, and some components of different embodiments may be combined. They are construed as being within the scope of the present disclosure.

The batteries according to the present disclosure can be used as secondary batteries such as all-solid-state lithium-ion batteries installed in various electrical devices or automobiles.

1. A battery comprising:
a first electrode;
a second electrode;
a solid electrolyte layer disposed between the first electrode and the second electrode; and
a hygroscopic material, wherein
the hygroscopic material is in contact with a side surface of the at least one selected from the group consisting of the first electrode, the second electrode, and the solid electrolyte layer.

2. The battery according to claim 1, wherein the at least one selected from the group consisting of the first electrode, the second electrode, and the solid electrolyte layer contains a solid electrolyte particle, and
the hygroscopic material covers at least a portion of a surface of the solid electrolyte particle.

3. The battery according to claim 1, wherein the first electrode contains an active material particle, and
the hygroscopic material is contained in the first electrode and covers at least a portion of a surface of the active material particle.

4. The battery according to claim 1, wherein the hygroscopic material is a particulate material.

5. The battery according to claim 1, wherein the hygroscopic material contains an ammonium halide.

6. The battery according to claim 5, wherein the hygroscopic material contains at least one selected from the group consisting of ammonium chloride and ammonium bromide.

7. The battery according to claim 5, wherein the at least one selected from the group consisting of the first electrode, the second electrode, and the solid electrolyte layer contains a halide solid electrolyte.

8. The battery according to claim 7, wherein the halide solid electrolyte contains at least one element selected from the group consisting of chlorine and bromine.

9. The battery according to claim 1, wherein the solid electrolyte layer contains the hygroscopic material in a higher volume percentage than the first electrode and the second electrode.

10. The battery according to claim 1, wherein, when the battery is viewed in plan view, the hygroscopic material is present in a higher volume percentage in an outer peripheral area than in a central area.

11. The battery according to claim 1, wherein the solid electrolyte layer includes a first solid electrolyte layer and a second solid electrolyte layer,
the first solid electrolyte layer is disposed between the first electrode and the second solid electrolyte layer, and
the first solid electrolyte layer contains the hygroscopic material in a higher volume percentage than the second solid electrolyte layer.

12. The battery according to claim 11, wherein the second solid electrolyte layer does not contain the hygroscopic material.

13. The battery according to claim 1, further comprising a hygroscopic layer covering at least a portion of a side surface of at least one selected from the group consisting of the first electrode, the second electrode, and the solid electrolyte layer.

14. The battery according to claim 13, wherein the hygroscopic layer does not cover a side surface of the second electrode.

15. The battery according to claim 14, wherein the second electrode is a negative electrode.

16. The battery according to claim 1, wherein the hygroscopic material is contained in at least one selected from the group consisting of the first electrode, the second electrode, and the solid electrolyte layer.
